(19) United States
(12) Patent Application Publication
(10) Pub. No.: US 2019/0021353 A1
(43) Pub. Date: Jan. 24, 2019

(54) YOGURT PRODUCTION METHOD

(71) Applicants: AJINOMOTO CO., INC., Tokyo (JP); AMANO ENZYME INC., Nagoya-shi (JP)

(72) Inventor: Hiroaki SATO, Kawasaki-shi (JP)

(73) Assignees: AJINOMOTO CO., INC., Tokyo (JP); AMANO ENZYME INC., Nagoya-shi (JP)

(21) Appl. No.: 16/144,461

(22) Filed: Sep. 27, 2018

Related U.S. Application Data
(63) Continuation of application No. PCT/JP2017/012838, filed on Mar. 29, 2017.

(30) Foreign Application Priority Data
Mar. 30, 2016 (JP) 2016-069184

(51) Int. Cl. A23C 9/12; A23C 9/123; A23C 9/13

(52) U.S. Cl. CPC A23C 9/1209; A23C 9/13; A23C 9/123

(57) ABSTRACT

The present invention aims to provide a production method of low-fat and low-protein yogurt with smooth taste, suppressed syneresis and superior shape retainability, including adding protein glutaminase and starch to raw milk.

### CROSS REFERENCES TO RELATED APPLICATIONS

This application is a continuation of International Patent Application No. PCT/JP2017/012838, filed on Mar. 29, 2017, and claims priority to Japanese Patent Application No. 2016-069184, filed on Mar. 30, 2016, both of which are incorporated herein by reference in their entireties.

### BACKGROUND OF THE INVENTION

### Field of the Invention

The present invention relates to a production method of yogurt, comprising adding a particular enzyme and starch.

### Discussion of the Background

In view of the growing interest in health in recent years, ingestion of fermented milk products such as yogurt and the like having various functions is increasing. On the other hand, preference of consumers also diversifies, and improvements in not only the functionality but also taste and flavor of yogurt are required. Under such circumstances, for example, a method for producing cheese and yogurt having a smooth mouthfeel and suppressed sour taste and bitter taste by adding a protein deamidase to raw milk is known (patent document 1).

In addition, the number of consumers who care about the calorie of food increases, and also in the yogurt market, the demand for low-calorie yogurt such as low-fat yogurt, nonfat yogurt and the like is increasing. However, many of the low-fat or nonfat yogurts are very light, watery and lack body taste. To solve such problems, a method for improving smoothness to a level similar to that of conventional yogurt by using a protein deamidase is known (patent document 2).

In addition, the development of low-protein yogurt is desired for healthy individual and patients with particular diseases seeking a low-protein as well as low-fat diet. However, since low-fat or low-protein yogurt has a small solid content, syneresis increases during preservation, thus causing a problem of shape retainability. To solve such problem, naturally occurring agar and gelatin widely used in yogurt, and gums such as carrageenan, xanthan gum, and the like may be used in some cases. However, it is known that the properties peculiar to gums affect the mouthfeel and prevent natural feeling.

### DOCUMENT LIST

### Patent Documents

patent document 1: JP-B-4711464
patent document 2: JP-B-5627022

### SUMMARY OF THE INVENTION

Accordingly, it is one object of the present invention to provide a production method of low-fat and low-protein yogurt with smooth taste, suppressed syneresis and superior shape retainability.

These and other objects, which will become apparent during the following detailed description, have been achieved by the inventors' discoveries that low-fat and low-protein smooth yogurt with good taste, suppressed syneresis and superior shape retainability can be obtained by adding protein glutaminase and starch.

Accordingly, the present invention provides the following.

[1] A method of producing yogurt comprising a step of adding protein glutaminase to raw milk and a step of adding starch to raw milk.
[2] The method of [1], wherein the raw milk has a fat content of milk of not more than 1.5 wt % and a protein content of not more than 5.5 wt %.
[3] The method of [1] or [2], wherein the starch has an average particle size of not less than 1 μm and less than 40 μm.
[4] The method of any of [1] to [3], wherein the amount of the starch to be added is not less than 0.1 wt % and not more than 10.0 wt % relative to the raw milk.
[5] The method of any of [1] to [4], wherein the amount of protein glutaminase to be added is not less than 0.05 unit and not more than 100 units per 1 g in weight of the milk protein in the raw milk.
[6] The method of any of [1] to [5], wherein the step of adding protein glutaminase is performed before a fermentation step.
[7] The method of any of [1] to [6], wherein the step of adding starch is performed before the fermentation step.

### Effect of the Invention

According to the present invention, yogurt with smooth taste like yogurt made from whole milk and with low calorie can be provided.

According to the present invention, low-fat and low-protein yogurt with improved manufacturability and preservation stability can be provided conveniently and at a low cost.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 shows a syneresis rate of each yogurt.

FIG. 2 shows the results of sensory evaluation of the smoothness of each yogurt.

FIG. 3 shows the results of sensory evaluation of the viscosity sense of each yogurt.

### DETAILED DESCRIPTION OF THE PREFERRED EMBODIMENTS

The present invention relates to a production method of yogurt, including a step of adding protein glutaminase and starch to raw milk (hereinafter sometimes to be abbreviated as “the method of the present invention”).

While the method of the present invention is characterized by the above-mentioned 2 steps, other steps such as the following conventional ones can be applied.

(1) a preparation step of raw milk
(2) a sterilizing step of raw milk
(3) a step of adding a starter
(4) a fermentation step

In the present invention, a step of adding protein glutaminase and a step of adding starch are further added. In addition to the above-mentioned, a cooling step and a step of adding other additive may also be included as appropriate.

### Preparation Step of Raw Milk

The raw milk in the present invention may be, for example, milk of mammals such as cow's milk, goat milk etc., defatted milk thereof, homogenized milk, processed milk, concentrates thereof, milk diluted with water, dried milk (powdered milk), or dry powdered milk suspended and dissolved in water.

The fat content of milk in raw milk in the present invention is generally not more than 1.5 wt %, preferably not more than 1 wt %, more preferably less than 0.5 wt %. The fat content of milk may be 0, generally not less than 0.1 wt %, preferably not less than 0.3 wt %. The component standard of milkfat in cow's milk in Japan is not less than 0.5% and not more than 1.5% of milkfat in low-fat cow's milk, and less than 0.5% in nonfat cow's milk.

The protein content in raw milk is generally not more than 5.5 wt %, preferably not more than 4 wt %, more preferably less than 4 wt %, further preferably not more than 3.5 wt %. In consideration of the addition of protein glutaminase, the content is not less than 0.5 wt %, preferably not less than 1.5 wt %, more preferably not less than 2.5 wt %.

As the raw milk in the present invention, commercially available nonfat milk may be used or, for example, milk containing milkfat and protein adjusted to fall within the above-mentioned ranges according to a conventional method of adjusting the concentration of milk protein in consideration of the amount of protein in defatted powdered milk by dissolving the defatted powdered milk and the like in water or the like may be used.

### Step of Adding Protein Glutaminase

The “step of adding protein glutaminase” characterizing the present invention may be performed at any stage of conventional production method of yogurt. For example, it is performed before a fermentation step using lactobacillus and the like or after the fermentation step, and before the fermentation step is preferable.

As the protein glutaminase in the present invention, a commercially available one or one prepared from a culture medium of a microorganism producing protein glutaminase can be used. As the preparation method thereof, a known method for protein separation and purification (centrifugation, UF concentration, salting out, various chromatographys using ion exchange resin and the like, etc.) can be used. For example, a culture medium is centrifuged to remove bacteria, after which salting out, chromatography and the like are combined to give the object enzyme. When an enzyme is recovered from bacteria, for example, bacteria are disrupted by pressurization treatment, sonication and the like, and separation and purification similar to the above are performed to give the object enzyme. The above-mentioned series of steps (disruption of bacteria, separation, purification) may also be performed after recovering the bacteria in advance from a culture medium by filtration, centrifugation treatment and the like. The enzyme may be powderized by a drying method such as freeze-drying, drying under reduced pressure and the like, during which a suitable excipient or a drying aid may also be used.

The kind of protein glutaminase in the present invention is not particularly limited as long as it directly acts on an amide group of protein to deamidate same without cleavage of peptide bond and crosslinking of protein. Examples of such enzyme include, but are not particularly limited to, protein glutaminases derived from Chryseobacterium, Flavobacterium or Empedobacter disclosed in JP-A-2000-50887, JP-A-2001-218590, WO 2006/075772, commercially available protein glutaminase derived from Chryseobacterium and the like.

The activity of the protein glutaminase to be used in the present invention can be measured by the following method.

(1) An aqueous solution (0.1 ml) containing protein glutaminase is added to 0.2 M phosphoric acid buffer (pH 6.5) (1 ml) containing 30 mM Z-Gln-Gly, and the mixture is incubated at 37° C. for 10 min and the reaction is discontinued by adding 0.4 M TCA solution (1 ml). As a blank, a mixture of 0.2 M phosphoric acid buffer (pH 6.5) (1 ml) containing 30 mM Z-Gln-Gly and 0.4 M TCA solution (1 ml) added with an aqueous solution (0.1 ml) containing protein glutaminase is incubated at 37° C. for 10 min.
(2) Using ammonia Test Wako (Wako Pure Chemical Industries, Ltd.), the amount of ammonia produced by the reaction of the solution of (1) is measured. The concentration of ammonia in the reaction mixture is determined from the analytical curve showing the relationship between the ammonia concentration and absorbance (630 nm), which was plotted using the ammonia standard solution (ammonium chloride).
(3) The activity of protein glutaminase is calculated from a predetermined formula with the amount of enzyme that produces 1 μmol of ammonia for 1 minute as one unit.

The amount of protein glutaminase to be added is generally not less than 0.05 unit, preferably not less than 0.1 unit, more preferably not less than 0.5 unit, per 1 g in weight of milk protein in raw milk. Similarly, it is generally not more than 100 units, preferably not more than 25 units, more preferably not more than 10 units. Smooth yogurt with low syneresis rate can be obtained when the amount is within the above-mentioned range.

### Step of Adding Starch

The “step of adding starch” characterizing the present invention may be performed at any stage of conventional production method of yogurt. For example, it is performed before a fermentation step using lactobacillus and the like or after the fermentation step, and before the fermentation step is preferable. It may also be added before and after the fermentation.

The starch in the present invention is not particularly limited as long as it is removed and purified from plants. Examples thereof include starch derived from potatoes such as white potato, sweet potato and the like, graincereals such as wheat, rice, corn and the like, vegetable, root vegetable, fruits. Of these, starch of potatoes or graincereals is preferable, that of white potato (bareisho), rice, wheat or corn is more preferable, that of rice, wheat or corn is further preferable, and that of rice or corn is particularly preferable.

The starch in the present invention is preferably starch free of pregelatinizing treatment (p starch). When unpregelatinized starch is used, the yogurt can be provided to not only healthy individuals but also patients in need of low GI (Glycemic Index) diet.

The average particle size of starch is generally less than 40 μm, preferably not more than 30 μm, more preferably not more than 20 μm, further preferably not more than 15 μm, from the aspects of smoothness and viscosity. From the aspects of mixability when used as a preparation, it is not less than 1 μm, more preferably not less than 2 μm.

The average particle size can be measured by a dynamic light scattering measurement method. For example, using dynamic light scattering apparatus Zetasizer Nano ZS (Malvern), 800 μl each of starch diluted 10-fold with MilliQ water is filled as a measurement sample in a vial and the particle size distribution and average particle size are measured by Autosampler (each test fraction n=3).

The amount of starch to be added is generally not less than 0.1 wt %, preferably not less than 0.5 wt %, and more preferably not less than 0.8 wt %, relative to the raw milk. From the aspect of cost, it is not more than 10 wt %, preferably not more than 8 wt %, more preferably not more than 5 wt %.

### Step of Adding Starter

In the method of the present invention, examples of the starter include lactobacillus and yogurt (starter culture) containing remaining live lactobacillus.

The amount of the starter to be added can be determined by a conventional method according to the kind of the raw milk and starter. For example, the amount of the lactobacillus starter (Chr. Hansen, YC-370) for yogurt to be added is generally 0.0001%-1%, preferably 0.01%-0.5%.

In the method of the present invention, the steps of adding protein glutaminase and starch may be performed simultaneously or performed with time difference. In addition, the steps of adding protein glutaminase, starch and starter may be performed simultaneously or performed with time difference.

### Fermentation Step

The temperature at which raw milk is fermented by adding starch, protein glutaminase and a starter is 0-80° C., preferably 3-50° C. The fermentation time is generally 1-8 hr, preferably 2-6 hr. The pH during fermentation is generally 3.5-6.0, and the fermentation is complete when it reaches 4.0-5.0.

These conditions can be appropriately modified or adjusted according to the purity of enzyme to be used, the kind and purity of protein and the like.

A specific production method of yogurt in the present invention includes preparing raw milk with fat and protein starting material within the above-mentioned range, adding additive and the like such as sugar, flavor and the like thereto as necessary, and homogenizing the mixture by a homogenizer and the like. Then, after sterilizing and cooling by a conventional method, starch, protein glutaminase and a starter (lactobacillus, yogurt containing remaining live lactobacillus, etc.) are added, filled in a container and fermented, or fermented in a tank and filled in a container to produce yogurt. When sturdy type yogurt is produced as necessary, the obtained yogurt may be disrupted using a sieve (e.g., pore size 500 μm) or a kitchen aid mixer.

The milk fat and protein contents of yogurt produced by the method of the present invention are the same as the milk fat and protein contents of raw milk since they hardly change due to lactic acid fermentation. While the yogurt in the present invention is not particularly limited, low-fat and low-protein yogurt is preferable. The content of milk fat and protein in the yogurt is generally not more than 1.5 wt % and not more than 5.5 wt % for each.

The starch content of the yogurt obtained by the method of the present invention is generally 0.1-10 wt %, preferably 0.5-5 wt %.

The shape of the yogurt in the present invention is, for example, solid, semi-solid or liquid, preferably solid or semi-solid. Specifically, set yogurt, sturdy yogurt and the like can be mentioned.

As the additive other than starch and protein glutaminase, the starting materials and additives generally used for the production of yogurt can be used. For example, carbohydrate, stabilizer, emulsifier, colorant, flavor adjuster, antioxidant and the like can be mentioned. Where necessary, vitamins, minerals, fruit pulp and fruit juice of strawberry and the like, solid food such as chocolate and the like, and the like may be added.

Other features of the invention will become apparent in the course of the following descriptions of exemplary embodiments which are given for illustration of the invention and are not intended to be limiting thereof.

### EXAMPLES

The present invention is further explained in the following by referring to Examples; however, the technical scope of the present invention is not limited by these examples. The sensory evaluation in the Examples was performed by, unless otherwise specified, a well-trained specialized panel that has engaged in food business for not less than 10 years. In the present specification, unless otherwise specified, % shows wt %.

### Production Example 1

### Preparation of Sturdy Yogurt

(1) As the starting materials, nonfat milk (lipid 0.1%, protein 3.5%; Koiwai Dairy Products CO., LTD.), and cow's milk (lipid 0.1%, protein 3.8%; Koiwai Dairy Products CO., LTD.) are used. Each milk is measured by 300 g, placed in a container and heated at 95° C. for 3 min.
(2) After heating, each milk is cooled to 50° C. in ice water.
(3) A starter (YC-370, Chr. Hansen Japan) (17.7 mg/mL milk) and protein glutaminase (PG) (500 U/g, Amano Enzyme Inc.) and various starches at the ratios indicated in Tables 3 and 4 are added to the above-mentioned milk.
(4) The mixture is fermented in an incubator at 44° C. for 4-5 hr until pH reaches 4.6.
(5) The yogurt obtained by fermentation is cooled to 20° C. in ice water.
(6) The yogurt is disrupted (sturdy) by a sieve (sieve-pore size 500 μm) and sufficiently cooled in a refrigerator.

### <Test Method 1>

### Measurement of Syneresis Rate

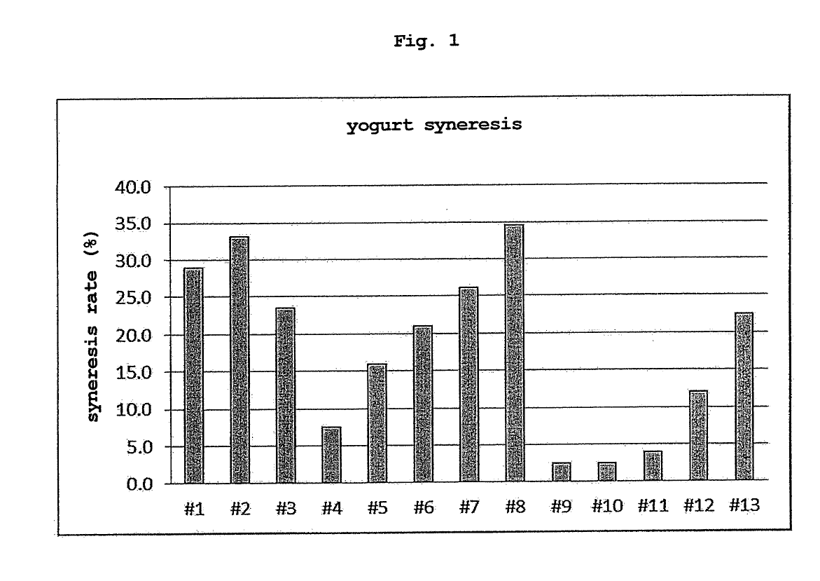

(1) For syneresis measurement, filter paper is placed on a cup, 20 g of yoghurt is placed on the filter paper and water is allowed to be discharged with gravity for 20 minutes.
(2) Water accumulated in the cup is measured and syneresis weight/yogurt initial weight is calculated as the syneresis rate (%). The results are shown in Tables 3 and 4 and FIG. 1.

### <Test Method 2>

### Viscosity Evaluation

Using a dynamic viscoelasticity measurement apparatus, the viscosity at 24° C. was measured. The viscosity at 100 (1/S) when the shear rate was increased to 0 [symbol] 100 (1/S) was measured. The results are shown in Tables 3 and 4.

### <Test Method 3>

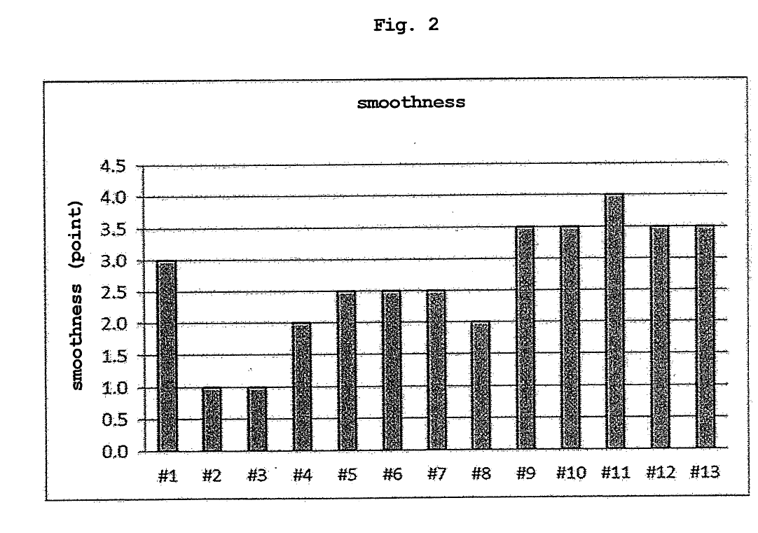

According to the criteria shown in the following Table 1 and with the “smoothness” being a mouthfeel when yogurt eaten is not felt rough and not remaining in the mouth, sensory evaluation was conducted in 7 stages by three expert panels. Average sensory evaluation of each panelist is shown in Tables 3 and 4 and FIG. 2.

TABLE 1

| | |
|---|---|
| 6 | very smooth and most preferable |
| 5 | very smooth and preferable |
| 4 | more smooth and preferable |
| 3 | smooth and tolerable |
| 2 | low smoothness |
| 1 | considerably lower smoothness |
| 0 | lowest smoothness |

### <Test Method 4>

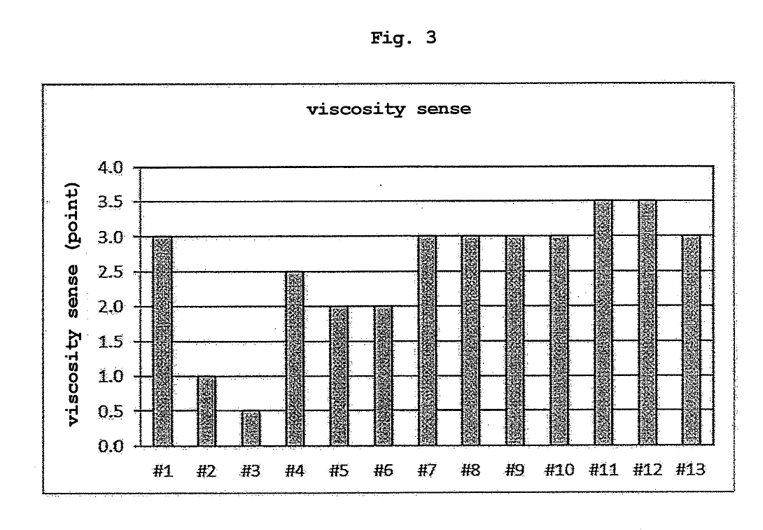

According to the criteria shown in the following Table 2 and with the strength of viscosity sensed from yogurt as “viscosity sense”, sensory evaluation was performed in seven stages by three expert panels. Average sensory evaluation of each panelist is shown in Tables 3 and 4 and FIG. 3.

TABLE 2

| | |
|---|---|
| 6 | very strong viscosity and most preferable |
| 5 | very high viscosity and preferable |
| 4 | higher viscosity and preferable |
| 3 | tolerable viscosity |
| 2 | low viscosity |
| 1 | very low viscosity |
| 0 | viscosity not felt |

### 5<Total Evaluation>

With the above-mentioned test results, total evaluation was performed according to the following criteria.

⊚: yogurt with high smoothness and viscosity and most preferable
◯: yogurt with appropriate smoothness and viscosity and very preferable
Δ: yogurt with appropriate smoothness and viscosity and preferable
x: unpreferable as yogurt

The results are shown in Tables 3 and 4. From the results of #9-#13 obtained by adding protein glutaminase and each starch and fermenting, it was confirmed that smooth yogurt with strong viscosity sense and low syneresis can be obtained even though it is low-fat and low-protein yogurt.

TABLE 3

| No. | #1 | #2 | #3 | #4 | #5 | #6 | #7 | #8 |
|---|---|---|---|---|---|---|---|---|
| protein % | 3.8 | 3.5 | 3.5 | 3.5 | 3.5 | 3.5 | 3.5 | 3.5 |
| lipid % | 0.1 | 0.1 | 0.1 | 0.1 | 0.1 | 0.1 | 0.1 | 0.1 |
| PG (U/g | | | 1.2 | | | | | |
| protein) | | | | | | | | |
| cornstarch (%) | | | | 1 | | | | |
| glutinous | | | | | 1 | | | |
| rice starch (%) | | | | | | | | |
| rice starch (%) | | | | | | 1 | | |
| wheat starch | | | | | | | 1 | |
| (%) | | | | | | | | |
| potato | | | | | | | | 1 |
| starch (%) | | | | | | | | |
| viscosity | 71.7 | 57.4 | 40.3 | 75.0 | 54.3 | 49.1 | 88.6 | 56.5 |
| (mPa sec) | | | | | | | | |
| syneresis | 28.9 | 33.2 | 23.5 | 7.5 | 16.0 | 21.0 | 26.1 | 34.5 |
| rate (%) | | | | | | | | |
| smoothness | 3.0 | 1.0 | 1.0 | 2.0 | 2.5 | 2.5 | 2.5 | 2.0 |
| (point) | | | | | | | | |
| viscosity | 3.0 | 1.0 | 0.5 | 2.5 | 2.0 | 2.0 | 3.0 | 3.0 |
| sense (point) | | | | | | | | |
| total | ∘ | x | x | x | x | x | x | x |
| evaluation | | | | | | | | |

TABLE 4

| | No. | | | | |
|---|---|---|---|---|---|
| | #9 | #10 | #11 | #12 | #13 |
| protein % | 3.5 | 3.5 | 3.5 | 3.5 | 3.5 |
| lipid % | 0.1 | 0.1 | 0.1 | 0.1 | 0.1 |
| PG (U/g protein) | 1.2 | 1.2 | 1.2 | 1.2 | 1.2 |
| cornstarch (%) | 1 | | | | |
| glutinous rice | | 1 | | | |
| starch (%) | | | | | |
| rice starch (%) | | | 1 | | |
| wheat starch (%) | | | | 1 | |
| potato starch (%) | | | | | 1 |
| viscosity | 47.1 | 56.1 | 61.8 | 74.0 | 60.8 |
| (mPa sec) | | | | | |
| syneresis rate (%) | 2.5 | 2.5 | 4.0 | 12.1 | 22.4 |
| smoothness | 3.5 | 3.5 | 4.0 | 3.5 | 3.5 |
| (point) | | | | | |
| viscosity sense | 3.0 | 3.0 | 3.5 | 3.5 | 3.0 |
| (point) | | | | | |
| total evaluation | ⊙ | ⊙ | ⊙ | ◯ | Δ |

As various starches, those described in Table 5 were used.

TABLE 5

| | | | average |
|---|---|---|---|
| | | | particle |
| kind | name | supplier | size |
| glutinous | Motiru B | Joetsu Starch Co., | 4-5 μm |
| rice starch | | Ltd. | |
| rice starch | Finesnow | Joetsu Starch Co., | 4-5 μm |
| | | Ltd. | |
| cornstarch | Nisshoku waxy | Nihon shokuhin kako | 15 μm |
| | cornstarch MD | co., ltd. | |
| wheat | Kitanoyuki | Kitaguni starch | 16-40 μm |
| starch | | | |
| potato | Nisshoku ginrei | Nihon shokuhin kako | not less |
| starch | | co., ltd. | than 40 μm |

### Production Example 2

### Preparation of Set Yogurt

(1) As the starting material, nonfat milk (lipid 0.1%, protein 3.5%; Koiwai Dairy Products CO., LTD.) is used. The nonfat milk (300 g) is measured, placed in a container and heated at 95° C. for 3 min.
(2) After heating, the nonfat milk is cooled to 50° C. in ice water.
(3) A starter (YC-370, Chr. Hansen Japan) (17.7 mg/mL nonfat milk), and protein glutaminase (PG) (500 U/g, Amano Enzyme Inc.) and rice starch (Finesnow described in Table 5) at the ratios indicated in Table 6 are added to the above-mentioned nonfat milk.
(4) The obtained mixture is divided by 40 g in a cup and fermented in an incubator at 44° C. for 4-5 hr until pH reaches 4.6.
(5) The yogurt produced by fermentation is cooled in a refrigerator.

The obtained yogurt was subjected to a test similar to the above-mentioned test methods 3 and 4, sensory evaluation was performed in seven stages by three expert panels according to the criteria shown in the above-mentioned Tables 1 and 2. Average sensory evaluation of each panelist is shown in Table 6. With the test results, total evaluation was performed according to the above-mentioned criteria.

TABLE 6

| | test fraction | | | |
|---|---|---|---|---|
| | | | | rice starch |
| | without | | rice | 1% + PG 1 |
| | addition | PG 1U/gp | starch 1% | U/gp |
| | No. | | | |
| | #1A | #2A | #3A | #4A |
| protein % | 3.5 | 3.5 | 3.5 | 3.5 |
| fat % | 0.1 | 0.1 | 0.1 | 0.1 |
| PG (U/g protein) | | 1.0 | | 1.0 |
| rice starch (%) | | | 1.0 | 1.0 |
| smoothness | 1.0 | 1.0 | 1.5 | 4.0 |
| (point) | | | | |
| viscosity sense | 1.0 | 0.5 | 2.0 | 4.0 |
| (point) | | | | |
| total evaluation | x | x | x | ⊙ |

As shown in Table 6, the results of #4A obtained by adding protein glutaminase and starch and fermenting them confirm that smooth yogurt with strong viscosity sense is obtained even though it is low-fat and low-protein yogurt.

### INDUSTRIAL APPLICABILITY

According to the present invention, smooth low-fat and low-protein yogurt superior in shape retainability can be provided.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method of producing yogurt, comprising:
(a) adding protein glutaminase to raw milk; and
(b) adding starch to raw milk.

2. The method according to claim 1, wherein said raw milk has a fat content of not more than 1.5 wt %, based on the weight of said raw milk, and a protein content of not more than 5.5 wt %, based on the weight of said raw milk.

3. The method according to claim 1, wherein said starch has an average particle size of not less than 1 μm and less than 40 μm.

4. The method according to claim 2, wherein said starch has an average particle size of not less than 1 μm and less than 40 μm.

5. The method according to claim 1, wherein the amount of said starch added to said raw milk is not less than 0.1 wt % and not more than 10.0 wt %, relative to the weight of said raw milk.

6. The method according to claim 2, wherein the amount of said starch added to said raw milk is not less than 0.1 wt % and not more than 10.0 wt %, relative to the weight of said raw milk.

7. The method according to claim 3, wherein the amount of said starch added to said raw milk is not less than 0.1 wt % and not more than 10.0 wt %, relative to the weight of said raw milk.

8. The method according to claim 1, wherein the amount of protein glutaminase added to said raw milk is not less than 0.05 unit and not more than 100 units per 1 g in weight of milk protein in said raw milk.

9. The method according to claim 2, wherein the amount of protein glutaminase added to said raw milk is not less than 0.05 unit and not more than 100 units per 1 g in weight of milk protein in said raw milk.

10. The method according to claim 3, wherein the amount of protein glutaminase added to said raw milk is not less than 0.05 unit and not more than 100 units per 1 g in weight of milk protein in said raw milk.

11. The method according to claim 5, wherein the amount of protein glutaminase added to said raw milk is not less than 0.05 unit and not more than 100 units per 1 g in weight of milk protein in said raw milk.

12. The method according to claim 1, wherein said adding protein glutaminase to said raw milk is performed before fermentation.

13. The method according to claim 2, wherein said adding protein glutaminase to said raw milk is performed before fermentation.

14. The method according to claim 3, wherein said adding protein glutaminase to said raw milk is performed before fermentation.

15. The method according to claim 5, wherein said adding protein glutaminase to said raw milk is performed before fermentation.

16. The method according to claim 1, wherein said adding starch to said raw milk is performed before fermentation.

17. The method according to claim 2, wherein said adding starch to said raw milk is performed before fermentation.

18. The method according to claim 3, wherein said adding starch to said raw milk is performed before fermentation.

19. The method according to claim 5, wherein said adding starch to said raw milk is performed before fermentation.

20. The method according to claim 12, wherein said adding starch to said raw milk is performed before fermentation.
